(19) United States
(12) Patent Application Publication
(10) Pub. No.: US 2003/0101288 A1
(43) Pub. Date: May 29, 2003

(54) Tracking features of devices

(76) Inventors: Joel Tague, Nampa, ID (US); Tommy Mouser, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/993,597

(22) Filed: Nov. 27, 2001

(51) Int. Cl. G06F 13/10

(52) U.S. Cl. 709/321

(57) ABSTRACT

Methods and systems for tracking features of a given device are provided. A representative method includes: collecting information regarding the intended use of a first feature of a device by a user; and providing information that corresponds to the device so that a first feature of the device exhibits a second mode of operation, provided the collected information indicates that the user intends to use the first feature, thereby enabling the functionality of the first feature. Systems, devices, and other methods are also provided.

### FIELD OF THE INVENTION

The present invention generally relates to computing devices. More specifically, the invention relates to methods and systems for tracking usage of features related to the computing devices.

### DESCRIPTION OF THE RELATED ART

Microprocessors and memory devices are key elements in computing devices. When power is initially applied to a computing device, typically, a microprocessor attempts to read a particular memory address in a non-volatile memory device to receive preliminary instructions. After reading the preliminary instructions, the microprocessor executes the instructions thereby permitting the computing device to become operational. This process is commonly known as “booting.” As a result of a “boot” process, the microprocessor transitions from a non-functional mode to an operational mode by reading and executing instructions commonly provided as firmware.

By way of example, the Basic Input/Output System (BIOS) in a Personal Computer (PC) typically is provided as firmware that dictates what the PC can accomplish without accessing programs from a disk storage device. The BIOS typically contains all the programming code required to control the keyboard, display monitor, mouse, disk drives, serial communication ports, and a number of miscellaneous functions. The BIOS is typically placed in a read only memory (ROM) integrated circuit device that is included within the PC. This mode of delivering the BIOS ensures that the BIOS is available and should not be damaged by disk failures. It also enables a PC to “boot” itself. After the PC has successfully loaded and executed the BIOS, the PC may then be configured to load an operating system into random access memory (RAM).

The BIOS in a personal computer is not the only type of firmware. Firmware may contain all the programming code required to control the keyboard, display monitor, mouse, mobile data storage, other input/output devices such as printers, and a number of miscellaneous functions. In order to ensure that the firmware is available for the microprocessor, the firmware may be stored in non-volatile memory. It is significant to note that the term “volatile” refers to memory devices that generally lose data stored therein upon the loss of power. Thus, a non-volatile memory device refers to a memory device that does not lose stored data upon the loss of power.

As personal computers, input devices, output devices, and operating systems develop over time, so to do their accompanying firmware. Oftentimes there are several different versions of firmware available for the same device. Different versions for printers, for example, could contain different features of the printer available to the user.

One shortcoming of firmware is that it takes up space, typically ROM space. As more and more features are added, the firmware required to provide for the features typically increases. This creates a need for more and more ROM space. ROM space is typically located on a hard drive, but could, for example, be located on a dedicated IC chip and could be housed in a PC or printer. As more firmware is added, more nonvolatile memory is required to store the firmware. Typically, the more memory required in a device, the higher the cost of the overall device.

Another shortcoming is that firmware typically becomes outdated by newer or better versions. However, previous versions are still installed because it is thought that some users might still use some of the, now outdated, features. These outdated features can take up valuable memory and add to the cost of the system without, possibly, yielding any usefulness to the end user.

Additionally, each feature that is provided by the firmware traditionally requires maintenance and support to the user by the provider. This also can be an added cost that is continual throughout the life of the firmware.

Based on the foregoing, it should be appreciated that there is a need for improved methods and systems that address the aforementioned and/or other shortcomings of the prior art.

### SUMMARY OF THE INVENTION

The present invention relates to tracking features of a given device that has at least a first feature. The first feature has at least a first mode and a second mode of operation. In particular, in the first mode, the functionality of the first feature is disabled and, in the second mode, the functionality of the first feature is enabled. In this regard, a representative method includes: collecting information regarding the intended use of the first feature by a user; and providing information that corresponds to the device such that the device exhibits the second mode of operation of the first feature, provided the collected information indicates that the user intends to use the first feature, thereby enabling the first feature.

Other embodiments of the invention may be construed as systems for tracking features of a given device. In this regard, a representative system includes a device that is configured to receive an instruction capable of switching the mode of a feature. The system also incorporates programmable logic corresponding to the first feature, a first nonvolatile memory element configured to house the programmable logic, and a second nonvolatile memory element configured to contain information exhibiting respective modes of the feature.

Another embodiment of such a system includes an information system configured to collect information regarding the intended use of a first feature of a device by a user. The information system is also configured to provide information that corresponds to the device such that the device exhibits the second mode of operation of the first feature, provided the collected information indicates that the user intends to use the first feature.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a functional block diagram of one embodiment of the feature tracking system of the present invention.

FIG. 2 is a functional block diagram of another embodiment of the feature tracking system.

FIG. 3 is a detailed diagram of the embodiment of the feature tracking system of FIG. 2.

FIG. 4 is a functional flow chart of the general method of the present invention.

FIG. 5 is a functional flow chart of a method for tracking the features of a device using the information system of FIG. 1.

FIG. 6 is a functional flow chart of another embodiment of the method of FIG. 5.

FIG. 7 is a functional flow chart of a method in which the features of a device are enabled.

FIG. 8 is a functional flow chart of the method of FIG. 7 in more detail.

FIG. 9 is a schematic of a representative allocation of memory associated with programmable logic of enabled and/or disabled device features.

### DETAILED DESCRIPTION

As will be described in greater detail herein, features tracking systems and methods of the invention can track features of a given device by receiving information regarding the use of a particular feature or features. The information then can be analyzed and conclusions drawn based upon the collected information. For instance, if the collected information reveals that a feature is no longer being used, the provider of the feature could discontinue providing firmware related to the feature in subsequent versions of the device and/or discontinue maintaining the firmware. This could greatly lower the cost of the device as well as maintenance.

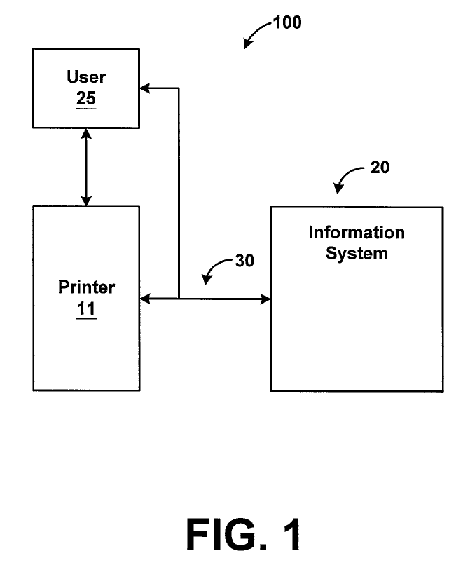

Reference is now made to FIG. 1, which is a functional block diagram of an embodiment of the features tracking system 100 of the present invention. The features tracking system of 100 includes a device, in this example, a printer 11, in communication with an information system 20 via a communication link 30. The communication link 30 could be over any medium of communication such as telephone, fax, email, mail, internet, etc. The printer 11, contains a feature(s) of which a user 25 intends to use. Examples of features could be half-tone printing, inverse imaging, econo-mode, etc.. The printer 11 houses memory elements (not shown) that contain firmware related to the features. In operation, if the user 25 attempts to use a feature of the printer and the feature is presently not enabled, the user 25 can establish the communication link 30 with the information system 20. The information system 20 then receives a request to enable the feature. In response, the information system 20 collects data regarding the intended use of the feature, and can provide an instruction(s) that enables the feature. The instruction could be any type of instruction through any medium. For example, the instruction could be a simple voice instruction told to the user 25 to perform a software command or an input code provided to the printer 11 (described later).

In some embodiments, the printer 11 can be configured to communicate directly with the information system 20 through the communication link 30. Therefore, if the user 25 desires to use a feature of the printer that is not currently enabled, the printer 11 could automatically acquire the communication link 30 with the information system 20. A request for enabling the firmware corresponding to a feature can then be sent by the printer 11. The information system then can provide an automated, e.g., electronic, response to the printer 11, so that the printer 11 can automatically enable the feature. In some embodiments, information corresponding to the user can also be provided to the information system 20.

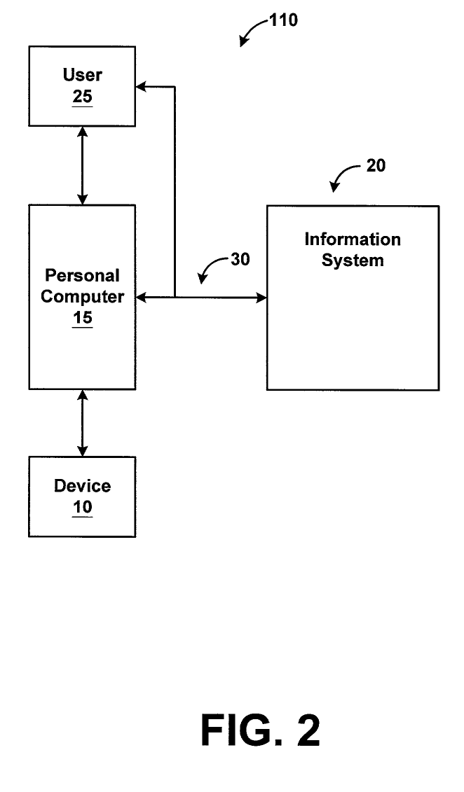

FIG. 2 is a functional block diagram of another embodiment of the features tracking system 110 of the present invention. The features tracking system 110 is similar to the features tracking system 100 except that an added client device, in this example, a personal computer 15 (PC) is in communication with a device 10. The user 25 may be operating the PC 15 and could have indirect or direct control of the device 10. The device 10 could be, in this case, any computing device associated with a PC that has operational features, for example, but certainly not limited to: a mouse, a joystick, a scanner, a digital camera, a monitor, and a printer as well. Firmware of the device 10 corresponding to a feature(s) of the device 10 could be stored in memory elements (not shown) housed in the device 10 itself, or remotely in the PC 15. Similarly, the user 25, the device 10, and/or the PC 15, could be in communication with the information system 20 via the communication link 30.

In operation, if the user 25 desires to use a feature of the device 10 that is not currently enabled, a communication link 30 can be established with the information system 20 by the user 25. The information system 20 then receives a request to enable the feature. In response, the information system 20, collects data regarding the intended use of the feature, and responds with an instruction(s) that enables the feature. The instruction(s) could be performed by the user 25 on the PC 15 or the device 10 itself, or perhaps both. Upon completion of the instructions, the feature would be enabled for use by the device 10.

The aforementioned procedure could be done automatically. If, for instance, the user 25 desires to use a feature of the device 10 that is not currently enabled, the PC 15 could automatically establish the communication link 20 with the information system 20. Again, the information system 20 then receives a request to enable the feature. In response, the information system 20, collects data regarding the intended use of the feature, and responds with an instruction(s) that enables the feature. After the PC 15 performs the instruction(s), the feature would be enabled on the device 10 and available to the user 25.

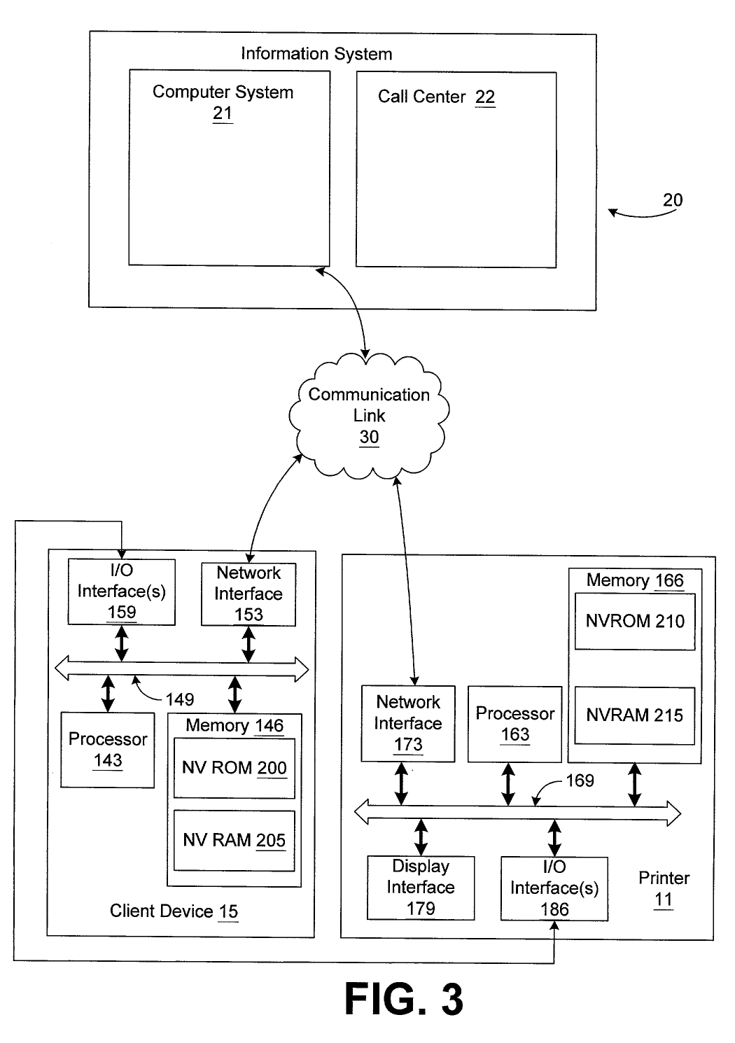

FIG. 3 is a detailed block diagram of the features tracking system 110 of FIG. 2. In this case, a printer 11 is in communication with a PC 15, and either the printer 11, the PC 15, or both, are in communication with an information system 20 via a communication link 30.

Generally, the printer 11 communicates with the PC 15 through an I/O interface 186 such as, for example, parallel port communication, printer port communication, network communication via a print server (not shown), etc.. Other input interfaces could be incorporated within the printer 11, such as user controlled toggle buttons like Mode, On Line, On/Off. The printer 11 may also include a processor 163, memory 166, and a network interface 173 all coupled via a local interface 169. The local interface 169 can be, for example, but not limited to, one or more buses or other wired or wireless connections, as is known in the art. The local interface 169 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 163 is a hardware device for executing software or firmware, particularly that stored in memory 166. The processor 163 can be any custom made or commercially available processor, a central processing unit (CPU), an auxiliary processor among several processors associated with the printer 11, a semiconductor based microprocessor (in the form of a microchip or chip set), a macroprocessor, or generally any device for executing software instructions.

The memory 166 can include any one or combination of volatile memory elements (e.g., random access memory (RAM, such as DRAM, SRAM, SDRAM, etc.)) and nonvolatile memory elements (e.g., ROM, hard drive, tape, NVRAM, CDROM, etc.). Moreover, the memory 166 may incorporate electronic, magnetic, optical, and/or other types of storage media. Note that the memory 166 can have a distributed architecture, where various components are situated remote from one another, but can be accessed by the processor 163. The present embodiment makes note of two types of memory elements, nonvolatile read only memory 210 (NVROM) and nonvolatile ready access memory 215 (NVRAM). The NVROM 210 could contain firmware associated with the various features of the printer 11. The NVRAM 215 could contain information related to the firmware stored in the NVROM 210. The network interface 173 could be a modem or network card wherein a communication link could be established with the printer 11. Other components are incorporated within the printer 11, such as the mechanical components required to perform the printing, but have been excluded for simplicity.

The PC 15 could contain the same general components as described above in the printer 11. In general, several I/O interfaces are available in the PC 15, such as a mouse port, keyboard port, display port, serial ports, and universal serial bus (USB) ports. The network interface 153 could be a modem or a network card wherein a communication link 30 could be established with the PC 15. The memory 146 could contain several different types of memory elements. Of note here, is the NVROM 200 and the NVRAM 205 of the PC 15. The NVROM 200 could contain firmware of several devices including the printer 11, remotely from the printer 11. Similarly, the NVRAM 205 could contain information related to the firmware stored in the NVROM 200 or even the NVROM 210 of the printer 11. The point is, the NVROM and NVRAM related to a particular piece of firmware may be stored either in the device itself or in a client device such as the PC 15.

The information system 20 may be coupled with the printer 11 or the PC 15 by the communication link 30. Generally, the information system 20 may be comprised of a call center 22 and a computer system 21. The call center 22 could have customer service representatives on hand to collect and provide information to users via telephone, mail, fax, email, etc.. The computer system 21 may be in communication with the PC 15 or the printer 11 and automated to respond to a received request from the PC 15 or the printer 11. The information system 20 could then, either through the call center 22, or automatically through the computer system 21, collect user information, store the information in a database, and gather the appropriate instructions to send to the PC 15 or the printer 11. The computer system 21 could be, for example, web based, or perhaps a server system with a collection of databases

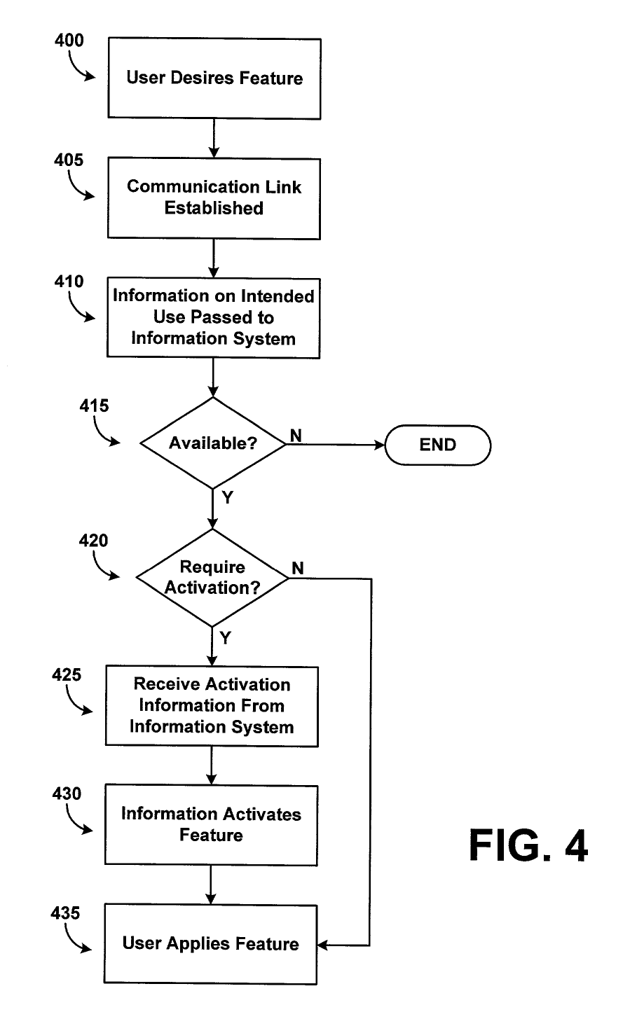

FIG. 4 is a flowchart illustrating functionality performed by one embodiment of the features tracking system. With regard to all flowcharts described herein, each block represents a module, step, segment, or portion of the process. It should also be noted that in some alternate implementations, the functions noted in the blocks may occur out of the order depicted. For example, two blocks shown in succession may in fact be executed substantially concurrently, or the blocks may sometimes be executed in the reverse order, depending upon the functionality involved.

As shown in FIG. 4, the process begins when a user desires to use a feature of a device, which is depicted in block 400. For this example, suppose the device was the printer 11 (FIG. 3) and the desired feature was half-tone printing. The provider of the firmware corresponding to half-tone printing may have provided it with the printer 11, but it is not currently enabled. In that case, the user 25 could establish the communication link 30 with the information system 20 (block 405). This link, as mentioned above, can be done over several possible mediums in several possible ways. To that, the link does not have to be established by the user 25; it could also be established by the printer 11 or the PC 15 in communication with the printer 11. The next step (block 410), would be to send or communicate data to the information system 20 via the communication link 30. The data could include, but is not limited to, the feature desired, the printer model, the user name, the user address, the intended amount of use of the feature, and other background data regarding the user 25.

The data is processed and it is determined whether the feature is available to the present printer model (step 415). If not, the user 25 is notified, a possible alternative could be suggested, and the process is terminated. If the feature is available, it is determined whether activation to make the feature enabled is required (step 420). If not, the user 25 is informed of an alternative feature, or a means of simply finding the feature and the user 25 proceeds to apply the feature (block 435). If the feature is found to be disabled, the user 25 could receive activation information from the information system 20 regarding the desired feature (block 425). The activation information could contain instructions to make the feature enabled. It should be noted that the printer 11 or the PC 15 in communication with the printer 11 could receive the information and could be performed by the user 25, or directly by the printer 11 or the PC 15. Once the instructions are complete the features would be enabled (block 430).

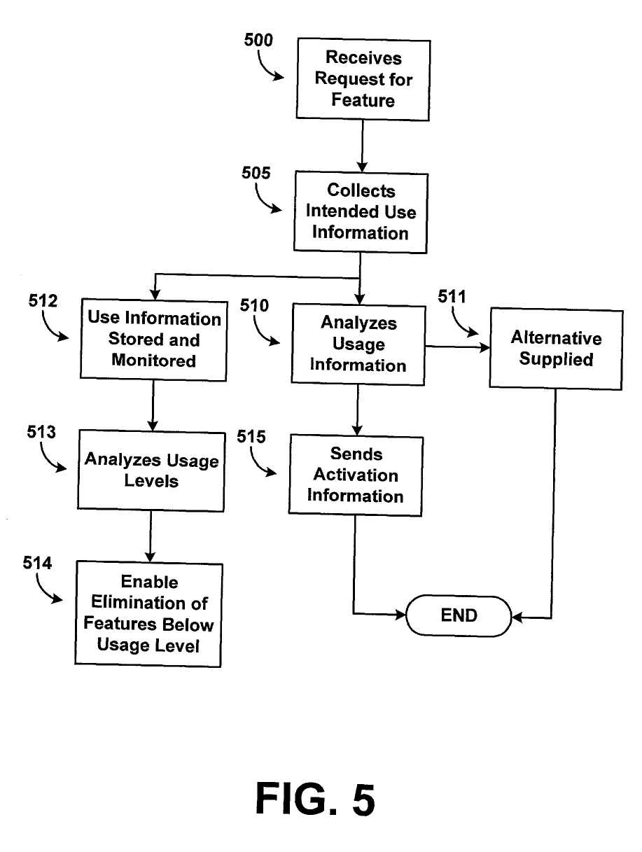

Now turning to FIG. 5, functionality of the information system 20 of an embodiment of the features tracking system will be described. As shown in FIG. 5, in block 500, a request for a particular feature is received. Data pertaining to the use of the feature, and possible other data pertaining to the user 25 is collected (block 505). The data is analyzed (block 510) and, if an alternative feature is found, data corresponding to the feature is communicated to the user 25 (block 511). Otherwise, the activation information required to enable the feature is communicated to the user 25 (block 515).

The information that is collected from the user 25 may also be stored and monitored (block 512) determined usage of the this feature (block 513). Upon analysis, this information can be utilized by the provider of the firmware and/or the device to make appropriate business and technical decisions, such as whether to continue to issue firmware for certain features and/or subsequent versions of the device, thus potentially saving the provider money on wasted memory space and/or maintenance costs of the device (block 514). Clearly, other possible results and conclusions could be drawn from this information.

It should be noted that this process would typically be done by the call center 22 if the user 25 had established the communication link 30. The computer system 21 could be configured to respond to the user 25 as well as the printer 11, or PC 15. Other means for collecting, analyzing, and responding to information could apply this general process, and it should be noted, the embodiments, as described above, are not intended to limit the present invention.

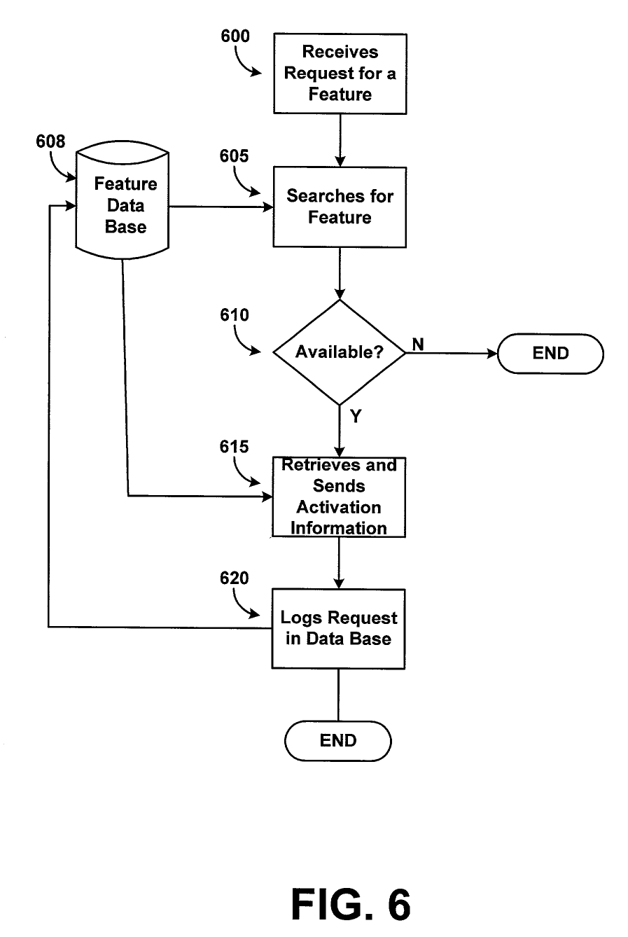

FIG. 6 is a flowchart illustrating functionality of an embodiment of an information system 20 of the present invention. As shown in FIG. 6, the process begins (block 600) when the computer system 21 receives a request by a device for a feature. In keeping with the present example, the device being the printer 11 or a PC 15 in communication with the printer 11. The data that is passed through the communication link 30 to the computer system 21 could be an encrypted signal, for example, or some other means of electronic communication. The computer system 21 searches a “Feature” database 608 to determine if the present feature is available (block 605). If not, the printer 11 or PC 15 could be notified; if it is available, activation information may be retrieved from the “Feature” database 608 and sent to the printer 11 or PC 15. In block 620, the information received upon the request for the feature is stored into the “Feature” database 608.

The “Feature” database 608 could be resident within the computer system 21 or remotely located. Over time, the database 608 could be queried, purged, and/or analyzed to find usage levels and/or patterns of particular features. Decisions can be made based upon the analyzed information, as described in FIG. 5.

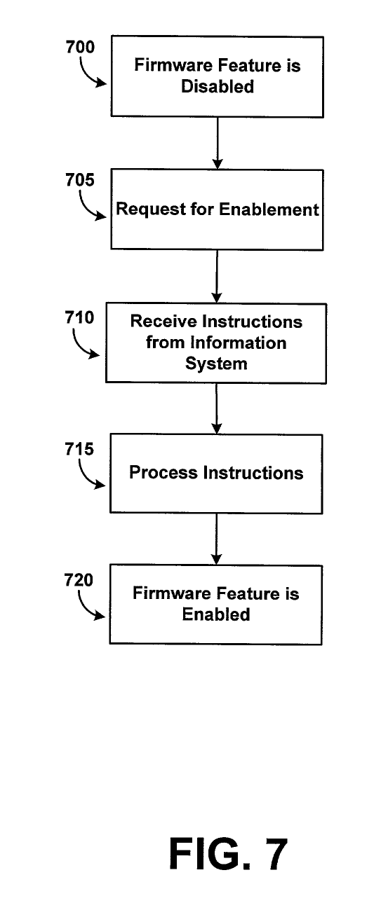

FIG. 7 is a flowchart illustrating a general method for enabling a desired feature. In its initial state, firmware associated with a given feature is disabled (block 700). The firmware could be stored either in the device itself or a coupled device such as a PC 15 (See FIG. 2). Assuming the user 25 wishes to use the given feature, a request to enable the associated firmware could be made by the user 25, the device 10, or the PC 15 (block 705). Upon receiving an activation instruction, the instruction could be processed and the firmware would become enabled, and subsequently, the feature made available.

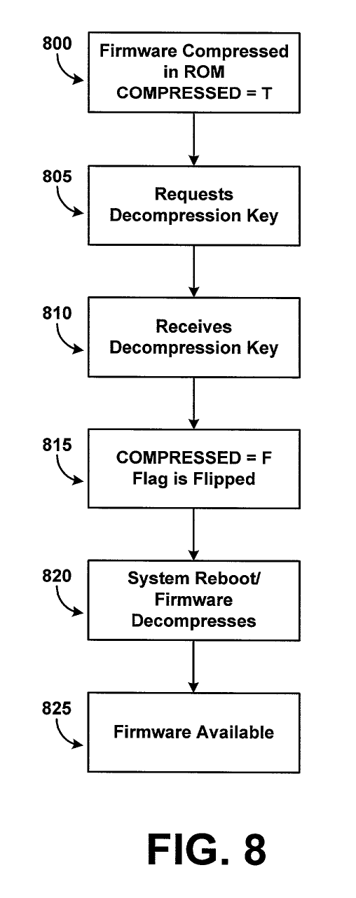

FIG. 8 is a flowchart illustrating an exemplary embodiment of the method for enabling a desired feature. In its initial state (block 800), firmware or some other form of programmable logic that is related to the desired feature would be in a compressed form and stored in the nonvolatile memory (NVROM) 210 of the printer 11. As stated above, the preferred embodiment calls for a printer as the device but any device that has desired features could be used. To that, the NVROM 200 of the PC 15 could store the firmware for any other device or for the printer 11, if the printer 11 itself does not have NVROM 210 which is the case for some printer models. The compressed form of the firmware saves space in the NVROM for other information. The firmware that is compressed would typically be related to features that the firmware provider believed to be rarely used but still were included with the device.

Each feature could exhibit at least two modes of operation. The first mode would exemplify the compressed state of the firmware, and thus a disabled state of the feature. The second mode would exemplify the decompressed state of the firmware, and thus an enabled state of the feature. A one-bit flag, for example, could be used to track the current mode of the firmware. Such a flag can be stored in the nonvolatile ready access memory (NVRAM) 215 of the printer. The flag could be stored in the NVRAM 205 of the PC 15 as well. This would be the case if no local NVRAM was available in the device. Such could be the case for some models of printers. If more than two modes of operation were available for each feature, for example, if different levels of the feature were available which allowed for different levels of decompression, than more than one-bit could be used in the flag.

When a user 25 desires a feature that is not currently enabled, the user 25, the printer 11, or the PC 15 could request a decompression key required to decompress the compressed firmware that is associated with the desired feature. This request may be sent (block 805) via the communication link 30 to the information system 20, where it would be processed. The decompression key, if available, is received (block 810) from the information system 20. In the case that the user 25 receives the key, the key could be a software command to perform on the PC 15 or perhaps a simple code to input into the printer 11 via its command buttons. In the case that the printer 11 or the PC 15 receives the decompression key, the key could be programmable logic configured to be processed automatically by the printer 11 or the PC 15. Again, the exact configuration of the decompression key is not critical.

The decompression key is processed to flip the compress/decompress flag which represents a switch in mode (block 815). Upon reboot of the printer 11 or the PC 15, if necessary, the printer 11 or PC 15 recognizes the mode of the feature and decompresses the related firmware (block 820). The firmware is now available for use.

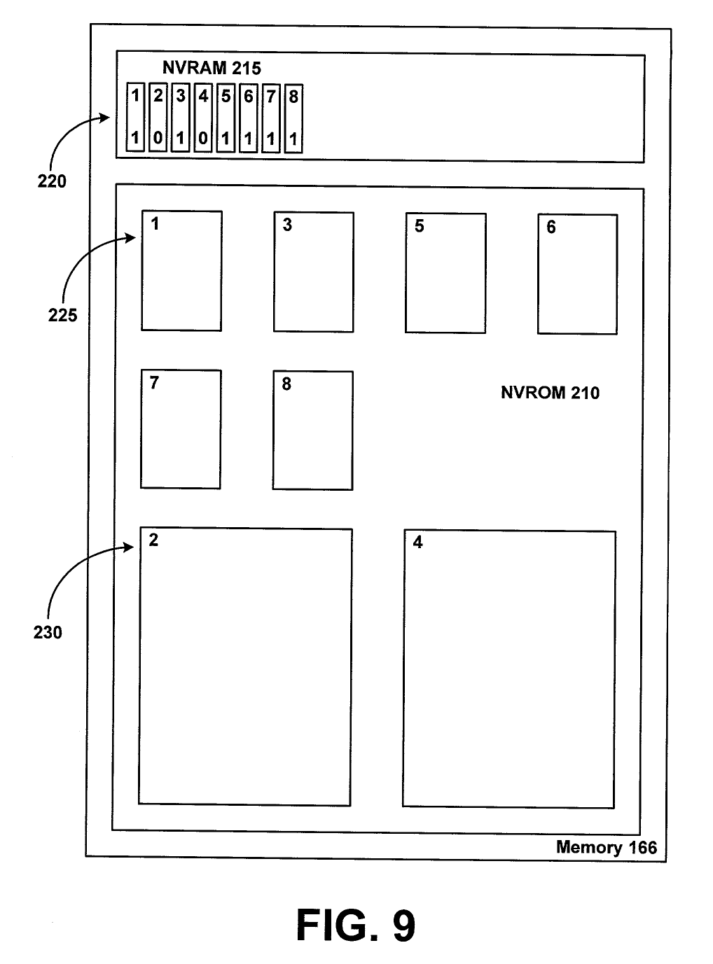

FIG. 9 is a schematic of the memory 166 of the printer 11 of FIG. 2. This could be the memory of any device configured to house memory such as the PC 15. As stated in the description of FIG. 2, the memory can comprise of a NVROM 210 and a NVRAM 215. The NVROM 210, may contain the compressed 225 and decompressed 230 form of the firmware. The NVROM 210 could contain other software or firmware not relevant to this exercise and so has been excluded for clarity. In one embodiment of the present invention, all the firmware may be included in one compressed/decompressed state and tracked by one one-bit flag 220. The schematic shows another embodiment in which the firmware is divided into segments. The division could separate the firmware so that the firmware required for each relevant feature is exclusive of any other. Each piece of firmware would then have a compressed state 225, a decompressed state 230, and a one-bit tracking flag 220. The simplified schematic shows tracking flags 220.2 and 220.4 with a logical “0” whereas the others are a logical “1”. The NVROM 210 houses the decompressed firmware 230.2 and 230.4 as well as the compressed firmware 225 of the others. Although certainly not to scale, the schematic attempts to show how storing the firmware in a compressed format can save much valuable memory space.

It will be appreciated that the methods for tracking features of a device accordance with the present invention may comprise an ordered listing of executable instructions, such as those sent from the information system 20 for implementing logical functions and can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the information system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable media would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention are merely possible examples of implementations set forth for a clear understanding of the principles of the invention. Many variations and modifications may be made to the above-described embodiment(s) of the invention without departing substantially from the spirit and principles of the invention. For example, it will be appreciated by those skilled in the art that the particular format of the information, and/or medium on which the information is communicated, could be chosen from any means capable of doing so. Additionally, other methods for converting a feature from one mode to another could be used. All such modifications and variations are intended to be included herein within the scope of the present invention and protected by the following claims.

1. A method for tracking features of a device, the device having at least a first feature, the first feature exhibiting at least a first mode and a second mode of operation, in the first mode, the functionality of the first feature is disabled and, in the second mode, the functionality of the first feature is enabled, the method comprising:
collecting information regarding the intended use of the first feature by a user; and
if the collected information indicates that the user intends to use the first feature, providing information that corresponds to the device such that the device exhibits the second mode of operation, thereby enabling the functionality of the first feature.

2. The method of claim 1, wherein, in the first mode of operation, information associated with the device is stored in a compressed state and the second mode of operation, information associated with the device is stored in a decompressed state.

3. The method of claim 1, wherein providing information comprises:
sending an instruction to the device, the instruction being configured to switch the mode of the first feature from the first mode to the second mode.

4. The method of claim 3, wherein the instruction is further configured to switch the mode of at least the first feature without switching modes of other features.

5. The method of claim 1, wherein collecting information comprises:
establishing a communication link; and
receiving the information via the communication link.

6. The method of claim 5, wherein the communication link is established by the device.

7. The method of claim 5, wherein the communication link is established by a second device in communication with the device.

8. The method of claim 1, wherein the device is a printer.

9. A system for tracking features of a device, the device having at least a first feature, the first feature exhibiting at least a first mode and a second mode of operation, in the first mode, the functionality of the first feature is disabled and in the second mode, the functionality of the first feature is enabled, the system comprising:
an information system configured to collect information regarding the intended use of the first feature by a user, the information system further configured to provide information that corresponds to the device such that the device exhibits the second mode of operation, provided the collected information indicates that the user intends to use the first feature, thereby enabling the functionality of the first feature.

10. The system of claim 9, wherein the information system comprises:
means for automatically receiving the information regarding the intended use of the first feature;
means for automatically collecting the information received; and
means for automatically sending information that corresponds to the device such that the device exhibits the second mode of operation of the first feature, provided the collected information indicates that the user intends to use the first feature, thereby enabling the functionality of the first feature.

11. The system of claim 10, wherein the information system further comprises:
means for analyzing the collected information.

12. The system of claim 9, wherein the device is a printer.

13. A features tracking system comprising:
a device having at least a first feature, the first feature exhibiting at least a first mode and a second mode of operation, in the first mode, the functionality of the first feature is disabled and, in the second mode, the functionality of the first feature is enabled, the device being further configured to receive an instruction capable of switching the mode of the first feature;
programmable logic corresponding to at least the first feature;
a first nonvolatile memory element containing the programmable logic; and
a second nonvolatile memory element configured to contain information exhibiting the mode in which the first feature is operating.

14. The system of claim 13, wherein the first feature is disabled when the programmable logic corresponding to the first feature is in a compressed state and enabled when the programmable logic corresponding to the first feature is in a decompressed state.

15. The system of claim 13, wherein the first nonvolatile memory is housed within the device.

16. The system of claim 13, wherein the second nonvolatile memory element is housed within the device.

17. The system of claim 13, further comprising:
a second device configured to communicate with the first device.

18. The system of claim 17, wherein the first nonvolatile memory element is housed within the second device, the first nonvolatile memory element containing the programmable corresponding to at least the first feature of the first device.

19. The system of claim 17, wherein the second nonvolatile memory element is housed within the second device, the second nonvolatile memory element being configured to contain information exhibiting the modes in which the features are operating.

20. The system of claim 13, wherein the device is a printer.
